(19) United States
(12) Patent Application Publication
(10) Pub. No.: US 2006/0065662 A1
(43) Pub. Date: Mar. 30, 2006

(54) Tray-shaped container of flexible material and relative manufacturing method and apparatus

(76) Inventors: Franco Goglio, Milano (IT); Maurizio Carcano, Pavia (IT); Giorgio Botiini, Gallarate (VA) (IT); Tommaso Tronbetia, Varese (IT)

Correspondence Address: LADAS & PARRY LLP, 224 SOUTH MICHIGAN AVENUE, SUITE 1600, CHICAGO, IL, 60604, US

(21) Appl. No.: 11/224,845

(22) Filed: Sep. 13, 2005

(30) Foreign Application Priority Data
Sep. 20, 2004 (EP) 04425703.8

(51) Int. Cl. B31B 45/00; B31B 1/64; B29C 51/14; A47J 37/01

(52) U.S. Cl. 220/573.1; 493/133; 493/152; 493/162; 428/34.1; 220/574; 156/224

(57) ABSTRACT

A container of flexible material and a relative production method, whereby the container, with at least three dimensions (sides) is formed from a flat sheet which is die-cut (2) in a polygonal shape from single- or multi-layer material by performing pleating of the portions of pleating (d) near the apexes, so as to raise—with respect to a bottom wall (a)—side walls (b) and connecting walls (c) between the adjacent side walls. A peripheral edge (10) of the blank is then folded over and secured to a stiffening frame, if any, having the same polygonal shape as the bottom of the blank. A covering sheet, also a single- or multi-layer sheet, can cover the container (1) and be removed by peeling or otherwise, an operation with is facilitated by the provision of a pull tab.

The present invention refers to a container with at least three dimensions (sides) constituting a tray of flexible material, and to a relative manufacturing method and apparatus for production of said tray.

In particular, the invention proposes a container as an alternative to the plastic containers currently existing on the market, injection moulded or thermoformed from a flat, high-thickness sheet of plastic or aluminium and drawn.

These are used above all for containing food products, also in the liquid or pasty state.

Such containers are made with different processes and are normally provided with a hingedly openable lid, beneath which may be disposed a sheet which tightly closes the container, or they are provided with a lid welded onto their upper part.

These containers are by nature rather costly.

In addition they have a substantially permanently rigid consistency, so that they occupy large volumes during disposal, thus further worsening the already serious problems of disposal of urban refuse.

Besides this, in the case of high barrier containers, the thickness of the barrier must be suitably high in order to ensure a low permeability to gas or to steam even at the points of greatest deformation and thinning of the wall.

This is particularly valid in the case of co-extrusions containing EVOH or consisting of a drawn aluminium foil.

The barriered plastic trays thus produced—that is by means of thermoforming—cannot be used for packaging moist foods (whose preservation often requires thermal sterilizing treatments) as the stretching process they have undergone tends to make the container collapse under the action of heat.

This does not happen, on the other hand, for containers made of metal, aluminium or drawn steel, but these containers are very expensive.

In any case, the drawing systems, both for plastic sheets and for aluminium sheets, require very costly machines and moulds, especially if high production rates are to be achieved.

The object of the invention is to provide a container that offers a valid alternative to the above containers, maintaining the advantages thereof and eliminating the drawbacks.

In particular, an object of the invention is to provide such a container that can be made in a simple, economical manner and at high speed.

Another object of the invention is to provide such a container that maintains a rigid consistency during use but that can be crumpled and considerably reduced in volume when being discarded, thus facilitating waste disposal.

Yet another object of the present invention is to provide a system for production of such a container that is economical and allows a high production speed.

These objects are achieved by the container according to the invention, which has the characteristics of appended independent claim 1, by a relative production method which has the characteristics of independent claim 8, and by an apparatus that has the characteristics of independent claim 13.

The container according to the invention is made of a flexible material, particularly single- or multi-layer plastic, possibly coupled with a layer of aluminium, which is very thin because it has only to provide a barrier effect without any supporting function.

The container is obtained from a blank—advantageously square, rectangular or polygonal in shape—whose areas near the corners are pleated, that is suitably folded inward and outward, so as to give the container, which takes on the shape of a three-dimensional tray, a certain capacity and consistency in the vertical direction.

Stiffening, if any, in the transverse direction can be obtained, on the other hand, by means of a small frame applied by heat-sealing, by gluing or by other means beneath the upper peripheral edge of the container or by folding of the edge.

The container is then advantageously closed by a sheet, peelable or not, preferably provided with a pull-tab.

Another characteristic that distinguishes the container thus formed if compared with the above-mentioned drawn types is the easy dressing and illustration on all sides.

The flexible material that forms the container can easily be printed with high-speed processes, reel to reel, since it is in any case of limited thickness (maximum 350 microns). Furthermore, construction of the container does not deform the printing, as happens with drawing processes.

Another property of the laminate forming the container is the possibility of having a susceptor function, that is of transforming microwave radiation into thermal energy by printing with inks having said property or by lamination of metallised films with a susceptor effect, all thanks to the homogeneous, planar structure thereof.

The susceptor activity of the laminate can be controlled by the amount of susceptor printing applied, so as to generate areas of the container with different heating, obtaining different cooking when placed in the microwave oven.

An exemplary embodiment of the invention is described hereunder with reference to the appended drawings, in which:

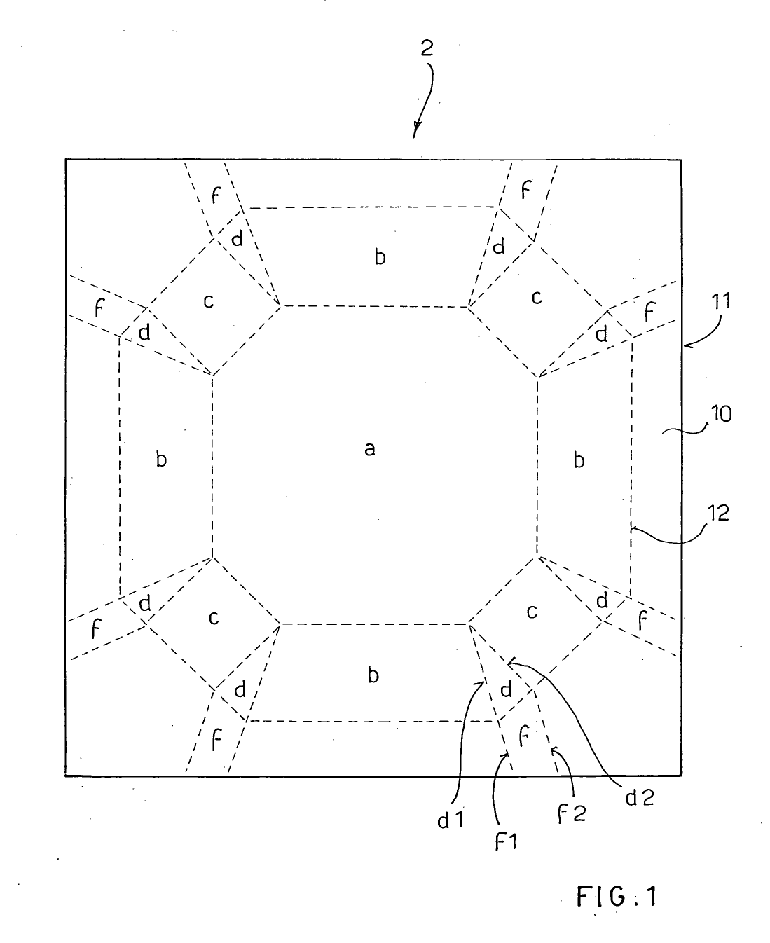

FIG. 1 is a plan view of a spread-out blank for obtaining a square container according to the invention in which the fold lines are indicated by dashed lines;

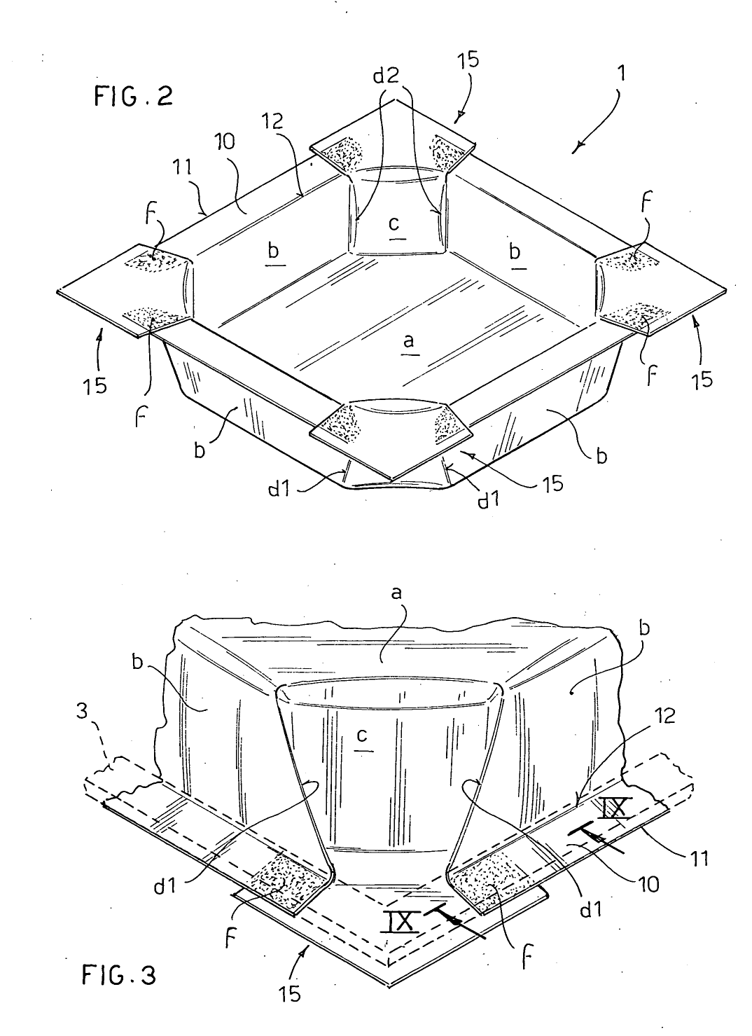

FIG. 2 is an axonometric view of the formed container, without the covering sheet;

FIG. 3 is an axonometric view of a detail of the container of FIG. 2 upside down, in which a stiffening frame is shown hatched;

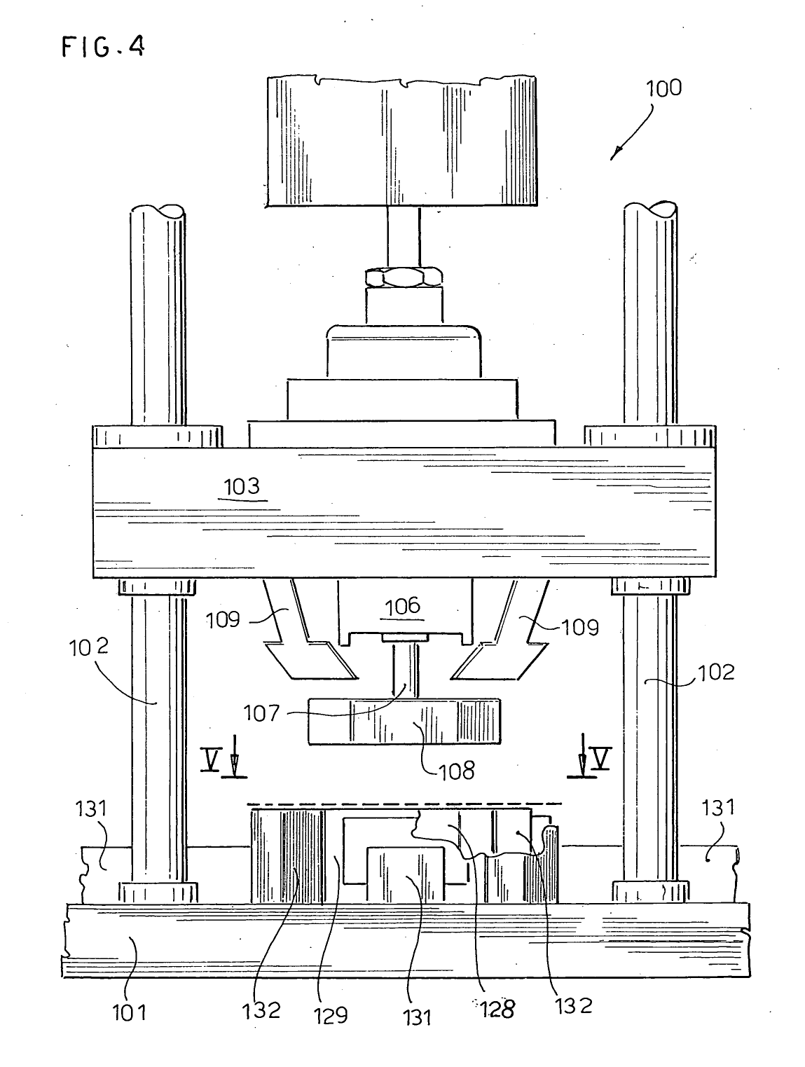

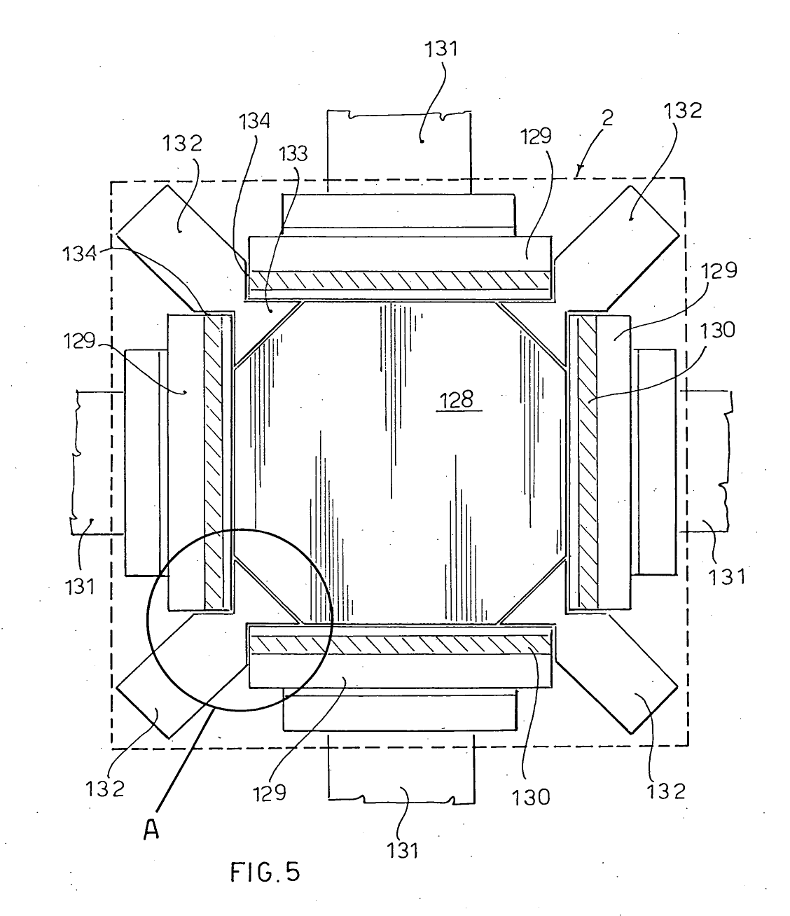

FIG. 4 is a side elevational view of an apparatus for producing the container according to the invention, in which the spread-out blank from which the container is obtained is shown hatched and, for the sake of clarity, parts of a side heating plate and a joining and folding plate have been cut away;

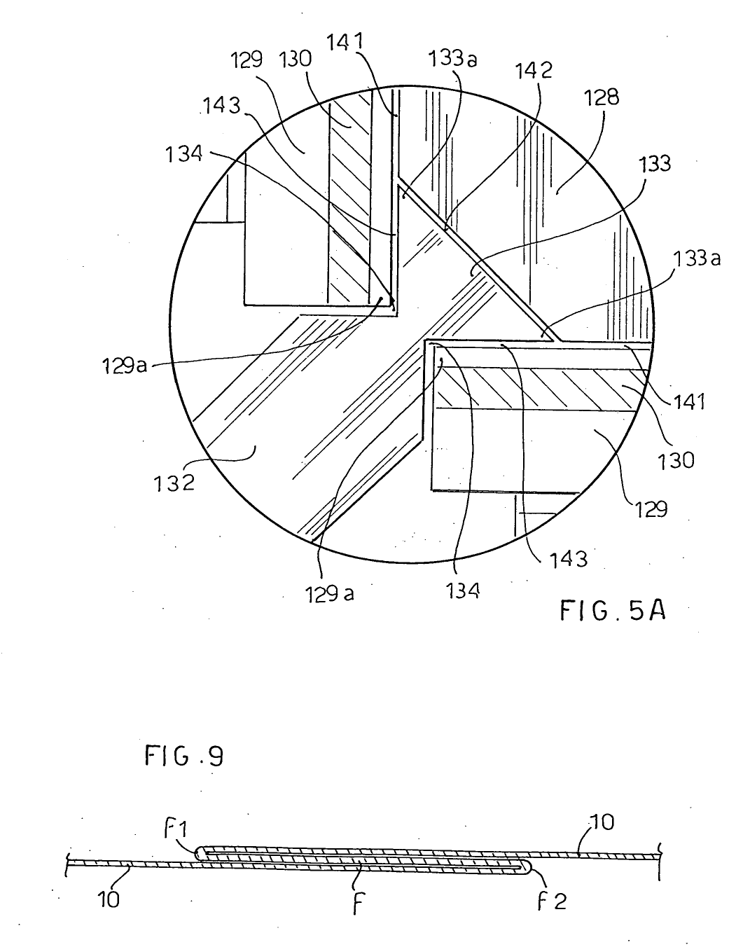

FIG. 5 is a top plan view, taken along the plane V-V of FIG. 4, in which the peripheral edge of the spread-out blank is shown hatched;

FIG. 5A is an enlarged view of the detail enclosed in the circle A of FIG. 5;

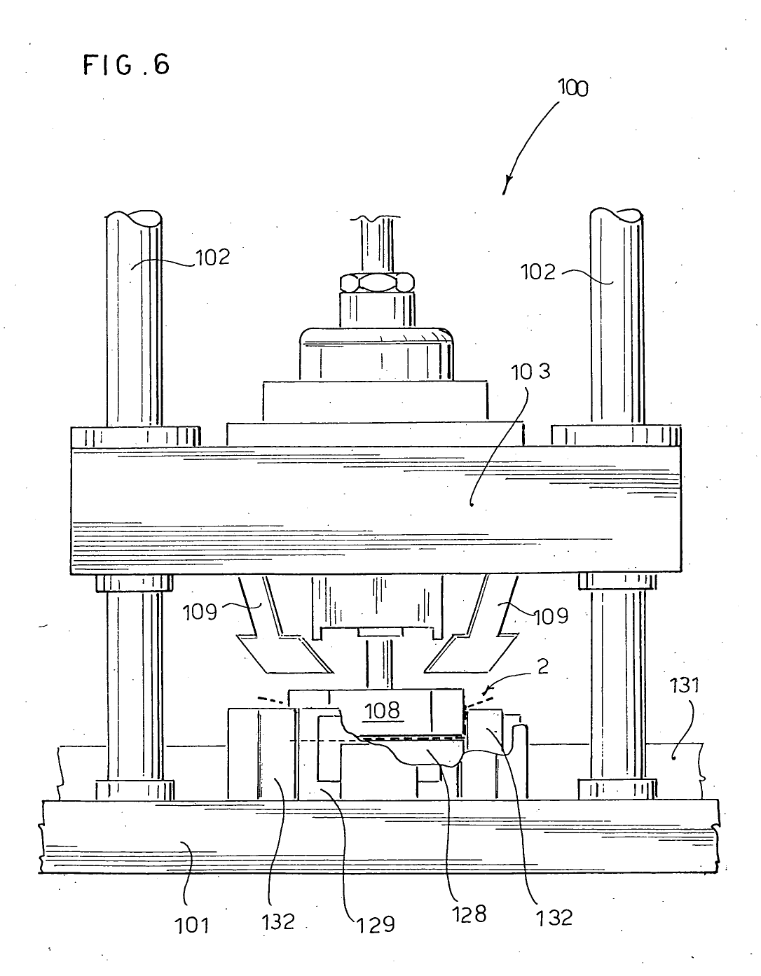

FIG. 6 is a side elevational view like FIG. 4, in which the top mould has been lowered for drawing of the blank, shown hatched, and the supports of the side heating plate have been omitted;

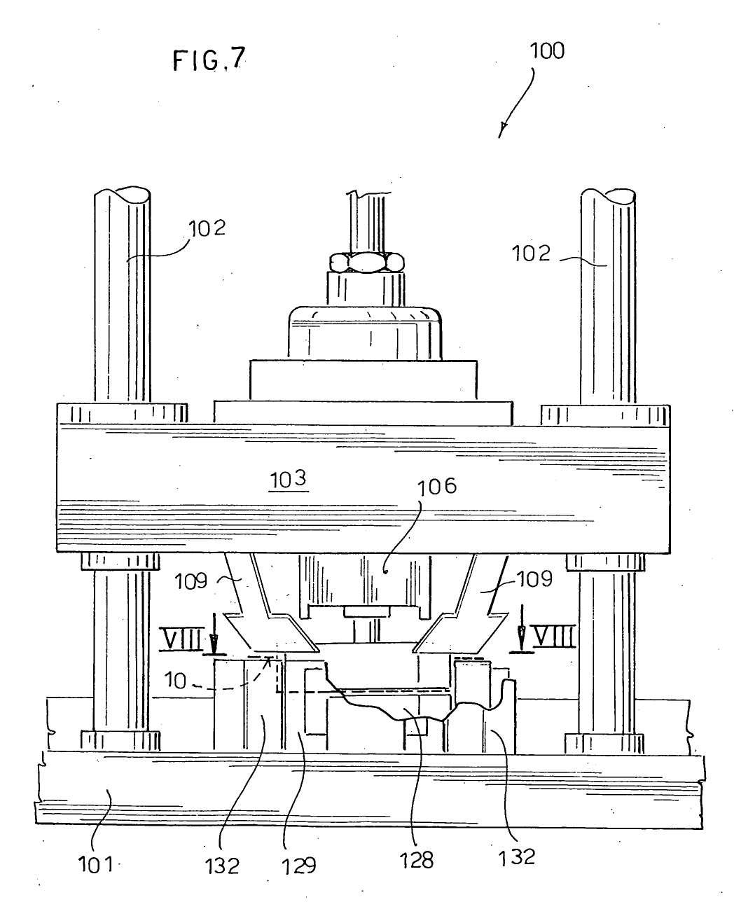

FIG. 7 is a side elevational view like FIG. 6, in which the inclined folding and heat-sealing plates have been lowered for folding of the corner edge and heat-sealing of the heat-sealing portions of the drawn blank shown hatched;

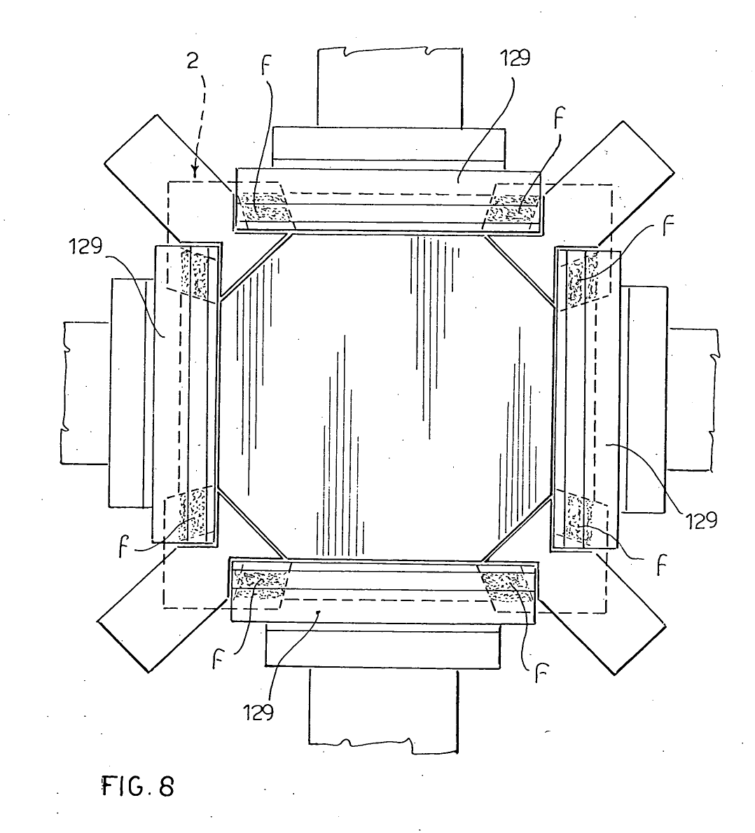

FIG. 8 is a top plan view, taken along the plane VIII-VIII of FIG. 7, in which the top mould has been omitted, the peripheral edge of the drawn blank is shown hatched and the heat-sealed portions are shown blackened; and

FIG. 9 is a partially broken off sectional view taken along the plane of section IX-IX of FIG. 3, illustrating an area of heat-sealing of the container according to the invention.

The container according to the invention is described with reference to FIGS. 1-3. For now, with reference in particular to FIG. 2, the container according to the invention, which is shaped as a tray of low height, has been indicated as a whole with reference numeral 1.

The container 1 is realised, in the way that will be described hereunder, starting from a blank 2, shown in FIG. 1, which is suitably folded and possibly stiffened with a frame 3, shown hatched in FIG. 2.

Said frame can be made in several ways. For example, it can be made by means of a continuously extruded wire strip developed from a reel which, when cut into segments, forms the frame without requiring the use of costly moulds. The material can have electrical conductivity characteristics so that welding can take place very swiftly by means of induction or ultrasound heating.

The container 1 is normally closed by a covering sheet 4, peelable or not, not shown in the figures. Before such closing, as shown in FIGS. 2 and 3, the formed container has corner portions 15 protruding outward with respect to the upper edge. After application of the covering sheet, the upper edge of the container is trimmed or die-cut, so as to obtain a substantially rectangular perimeter.

The manner in which the container 1 is made is now described, starting from the blank 2, which is a single- or multi-layer sheet of a material with one or more layers, in particular layers of plastic material—such as polyethylene, polyester, polypropylene, polyamide EVOH—and/or metals, such as aluminium.

In the appended Figures the square-shaped blank 2, which does not have breaks in continuity, gives rise to an octagonal tray, but clearly it could also be rectangular or generally polygonal in shape, in which case a tray of substantially the same polygonal shape would be formed, but with the addition of connecting sides at the corners.

In FIG. 1 the octagon denoted by a will form the bottom of the container 1, the four trapeziums indicated by b will form the side walls, whereas the squares c at the four apexes will form the four connecting walls between the four side walls b. The connecting walls c are obtained by pleating of the eight triangular portions d disposed between the connecting walls c and the side walls b. Pleating takes place by bringing the fold lines d1 between the side wall b and the triangle of pleating d toward the outside of the container and bringing the fold lines d2 between the connecting wall c and the triangle of pleating d toward the inside of the container.

A peripheral edge 10 of the blank 2, defined by the square outer edge 11 of the blank and by an inner octagonal peripheral line 12, dashed in FIG. 1, is folded over during formation of the container 1.

With reference to FIG. 1, eight trapezoidal areas f of heat-sealing are present in the peripheral edge coinciding with the eight triangles of pleating d, in which each area of heat-sealing f is defined by a first segment f1 which prolongs the fold line d1 between the side wall b and the triangle of pleating d and a second segment f2 which starts from an apex of the triangle of pleating d and is parallel to the first segment f1.

In practice, to form the container 1, the eight triangular portions d of the blank 2 are pleated. That is, each triangular portion d is folded inward with respect to the side wall b along the fold line d1 which is brought outward. Furthermore, each triangular portion d is folded outward with respect to the connecting wall c along the fold line d2, which is brought inward.

At the same time as pleating, the four side walls b are raised with respect to the bottom a, forming the four substantially vertical connecting walls c so as to increase the stiffness and the resistance to compression of the container 1. The square connecting wall c stiffens the corresponding corner of the container 1, especially in the vertical direction, acting as a strut.

The way in which folding of the triangular portions d of the blank 2 takes place is shown better in FIG. 3, which shows an enlargement of the apex of the container 1, where cuts in the laminate are not present in order to ensure the perfect tightness of the package.

Once the eight triangular portions d of the blank 2 have been folded, and thus the side walls b and the connecting walls c have been raised, the frame 3, which is made of a sufficiently rigid plastic material, is inserted, if necessary, from beneath and the peripheral edge 10 of the blank, is folded thereon and is fixed thereto with suitable means, such as heat-sealing, adhesive and the like.

The frame 3 gives the container 1 a stiffness prevalently in the transverse directions which, together with, the vertical stiffness imparted by the square connecting walls c acting as corner struts, determines a structure which is substantially rigid during use, despite being made in large part of flexible material.

The tray container 1 may then be closed with a suitable lid, for example by applying to the upper edge 10 thereof—by heat sealing, gluing or the like—a single- or multi-layer sheet 4. The protruding corner parts 15 are then trimmed so as to obtain a substantially rectangular and uniform upper peripheral edge The covering sheet can be removed by peeling or otherwise, an operation which is facilitated by providing a pull-tab thereon.

From the above description the advantages of the container according to the invention are evident, in that it is made in an extremely simple and economical manner being made up essentially of a blank 2 of flexible sheet material, of a substantially rigid frame 3 (if any) and of a covering sheet, if any.

The production process of the container 1 can easily be automated, providing for automatic pleating of the eight triangular portions d near the apexes of the blank 2, to form a parallelepiped tray, insertion of the frame, if any, and folding and fixing on the frame of the peripheral edge 10.

By way of example, with reference to FIGS. 4-8, an apparatus 100 is described for realising a tray-shaped container according to the invention.

With reference for now to FIG. 4, the apparatus 100 consists of a vertical press and comprises a base frame 101 on which are mounted vertical guide columns 102. A mobile plate or crosspiece 103, operated in vertical translation by means that are not shown, is mounted vertically slidably on the guide columns 102.

A support 106 is mounted in the mobile plate 103 and protrudes downward therefrom. A top mould 108 is fixed to the support 106 by means of a vertical shaft 107, provided with a certain vertical play. The top mould 108 is shaped substantially as an octagonal plate which reproduces the outline of the bottom a (FIG. 1) of the container to be realised.

Four folding and heat sealing plates 109 are connected to the mobile plate 103 and protrude downward, in an inclined manner, converging towards the four smaller sides of the top mould 108, that is to say the sides in register with the connecting walls c (FIG. 1) of the blank 2.

A bottom mould 128 is mounted, with a certain vertical play, on the base frame 101. The bottom mould 128 is mounted on compression spring means (not shown) ad has a vertical stroke selected to be equal to the depth of the container 2 that is to be formed.

A shown in FIG. 5, the bottom mould 128 has the same octagonal plate shape as the top mould 108 and is disposed in register therewith. Four heating side plates 129, provided with respective electrical heating resistances 130, are provided at the larger sides of the bottom mould 128. Each heating side plate 128 has a rectangular shape in a plan view, of a length equal to the distance between the two larger sides of the bottom mould 128. The front part of each heating side plate 129 is disposed near the larger side of the bottom mould 128 and the rear part is supported by a support 131 disposed on the base 101 of the machine.

Four connecting and pleating plates 132 are disposed to coincide with the smaller sides or connecting sides of the bottom mould 128. As shown better in FIG. 5A, each connecting and pleating plate 122 has in a plan view a triangular end portion 133 defined by two opposite L-shaped cuts 134, with an angle of 90°, within which the edges 129a of the two side heating plates 129 are received.

In this manner, the triangular portion 133 of the connecting and pleating plate is shaped as an isosceles triangle with the hypotenuse opposite the smaller side of the bottom mould 128. Two edges 133a with angles of 45° are subtended on the hypotenuse of the triangular part 133. The hypotenuse of the triangular part 133 is parallel to the smaller side of the bottom mould 128 and the catheti of the triangular part 133 are aligned with the larger sides of the bottom mould 128.

It should be noted that a first space 141 is formed between the larger side of the bottom mould 128 and the respective side heating plate 129, a second space 142 is formed between the smaller side of the bottom mould 128 and the hypotenuse of the triangular portion 133 and a third space 143 is formed between the cathetus of the triangular portion 133 and the respective side heating plate 129.

Returning to FIG. 4, in the resting state, the top surface of the bottom mould is at the same level as the top surface of the side heating plates 129 and of the connecting and pleating plates 132. As shown in FIG. 5, the flat blank 2 is disposed on the bottom mould 128 so that its peripheral part is disposed on the side heating plates 129 and on the connecting and pleating plates 132.

Then, as shown in FIG. 6, the mobile plate 103 is lowered so that the top mould 108 abuts on the bottom mould 128 causing it to be lowered to an end of stroke point, compressing the spring means. The stroke of the bottom mould 128 corresponds to the depth of the tray 2.

In this manner the blank 2, which is situated between the bottom mould 128 and the top mould 108, is drawn. That is to say the bottom wall a of the blank 2 is lowered with respect to the peripheral edge part 10, which remains on the side heating plates 129 and on the connecting and pleating plates 132.

In this manner:
the side walls b of the container are formed in the spaces 141 between the larger sides of the top mould 108 and the respective side heating plates 129;
the connecting walls c of the container are formed in the spaces 142 between the smaller sides of the top mould 108 and the respective hypotenuses of the triangular connecting plates 133; and
the triangular pleating parts d of the blank are pleated inside the respective spaces 143 between the cathetus of triangular pleating plate 133 and the side heating plate 129.

It should be noted that the fold line d2 of the triangle d is brought towards the inside of the container by means of the 45° edges 133a between the hypotenuse and the catheti of the triangular plate 133, whereas the fold line d1 is brought towards the outside by means of overlaying of the flaps inside the space 143 between the cathetus of the triangular pleating plate 133 and the heating plate 129.

In this situation, as shown in FIG. 6, the peripheral parts of the corners of the blank 2 are raised with respect to the top surface of the heating plates 129 and of the pleating plates 132. Thus, as shown in FIG. 7, the mobile plate 103 is lowered further, whereas as the top mould 108 remains still because it has reached its bottom end of stroke position.

As a result, the ends of the oblique folding and heat sealing plates 109, as they descend, fold the corner parts of the edge 10 of the blank 2 in abutment against the top surface of the connecting plates 133 and the end parts of the heating plates 129. Thus the oblique plates 109 act as heat-sealing counter-bars, pressing the portions of heat-sealing f on the heating plates 129.

During this operation, the heat-sealing part f (FIG. 1) is folded along the fold lines defined by the segments f1 and f2 and, as shown in FIG. 8, the heat-sealing part f is superimposed on the edge part 10 of the blank near the ends of the heating plates 129 in which, thanks to the pressure of the oblique plates 109, heat-sealing takes place.

As shown in FIG. 9, in the area of heat-sealing three superimposed layers of material are heat-sealed. That is to say, the heat-sealing part f is heat-sealed in a sandwich between two layers of the edge part 10. This type of heat-sealing ensures the tray shape of the container 1 is held well.

Once the heat-sealing is finished, the mobile plate 103 is raised together with the top mould 108, and then the spring means are released, raising the bottom mould 128 on which the formed container is disposed.

The container according to the invention is a valid alternative to thermoformed containers erected vertically, by means of suitable folds, from rigid or drawn materials and can be used—preferably but not exclusively—for food products.

Of course, the invention is not limited to the particular embodiment described above and illustrated in the appended drawings, but numerous modifications of detail within the reach of a person skilled in the art can be made thereto without thereby departing from the scope of the invention as set forth in the appended claims.

1. A container of flexible material, obtained from a polygonal shaped blank (2) of single- or multi-layer sheet material by pleating and folding of an outer peripheral edge (10) comprising:
a bottom wall (A),
a plurality of side walls (b) which are erected substantially at right angles from said bottom wall (a),
a plurality of connecting walls (c) disposed between said side walls (b) and obtained by means of pleating of portions of pleating (d) near the corners of said blank and disposed between said side walls (b) and said connecting walls (c), and
an upper peripheral edge (10) folded outward.

2. Container of claim 1, wherein said connecting walls (c) are substantially square or rectangular and are disposed at right angles to said bottom wall (A).

3. Container of claim 1, wherein said portions of pleating (d) are substantially triangular and comprise:
a first fold line (d1) adjacent to the side wall (b) and brought to the outside of the container, to give rise to an inward folding of said triangular portion (d) with respect to the respective side wall (b), and
a second fold line (d2) adjacent to the connecting wall (c) and brought toward the inside of the container, to give rise to an outward fold of said triangular portion (d) with respect to the respective connecting wall (c).

4. Container of claim 1, wherein it comprises a plurality of heat-sealed parts (f) disposed on the top peripheral edge (10) to coincide with said intermediate parts of pleating (d).

5. Container of claim 1, wherein it comprises an octagonal bottom wall (a), four side walls (b), four connecting walls (c) and eight pleating parts (d).

6. Container of claim 1, wherein said top peripheral edge (10) is folded outward and fixed on an underlying rigid frame, having the same polygonal shape as the bottom (a) of the container.

7. Container of claim 1, wherein it provides a removable covering sheet fixed by means of heat-sealing, adhesives or similar means, to the top edge (10) of the container.

8. A method for producing a container (1) of flexible material starting from a polygonal shaped blank (2) of single- or multi-layer sheet material, comprising the following steps:
pleating of portions of pleating (d) near the apexes of said blank (2) so as to raise—with respect to a bottom wall (a)—side walls (b) and connecting walls (c) acting as a reinforcement between two adjacent side walls (b),
outward folding of a peripheral edge (10) of the blank (2).

9. Method of claim 8, wherein said portions of pleating (d) are substantially triangular in shape and the pleating takes place by:
inward folding of said portion of pleating (d) with respect to the adjacent side wall (b) along a first fold line (d1), and
outward folding of said portion of pleating (d) with respect to an adjacent connecting wall (c) along a second fold line (d2).

10. Method of claim 8, wherein it provides for a step of heat sealing of said peripheral edge (10) along the areas of heat sealing (f) coinciding with said portions of pleating (d).

11. Method of claim 8, wherein said peripheral edge (10) of the blank (2) is folded and fixed to an (underlying) frame (3).

12. Method of claim 8, wherein it also provides for the application to said upper peripheral edge (10) of the container of a peelable covering sheet.

13. An apparatus (100) for production of the container (2) of claim 1, wherein it comprises:
a vertically mobile plate (103) connected to a top mould (108) shaped as a polygonal plate with a peripheral outline corresponding to the bottom (a) of the container,
a bottom mould (128) having the same shape as the top mould (108) disposed in register therewith and being vertically mobile with a stroke equal to the depth of the container,
a plurality of side plates (129) disposed near the sides of said bottom mould (128) so that between the sides of said bottom mould (128) and the side plates (129) respective first spaces are formed (141) in which the side walls (b) of the container are formed,
a plurality of connecting and pleating plates (132, 133) disposed between said side plates (129) and near the connecting sides of said bottom mould (128) so that:
between the connecting sides of said bottom mould and the connecting plates (133) respective second spaces (142) are formed within which the connecting walls (c) of the container are formed, and
between said pleating plates (133) and said side plates (129) respective third spaces (143) are formed within which pleating of the portions of pleating (d) of the container takes place.

14. Apparatus of claim 13, wherein said connecting and pleating plates (132) comprise a triangular end wall (133) defined by two opposite L-shaped cuts (134) within which the edges (129a) of said side plates (129) are positioned, so that:
said second space (142) for formation of the connecting walls is formed between the hypotenuse of said triangular part (133) and the connecting side of the bottom mould, and
said third space (143) for pleating of the portions of pleating is formed between the catheti of said triangular part (133) and the side plates.

15. Apparatus of claim 13, wherein said side plates (129) comprise an electrical heating resistance (130) for sealing of the sealing portions (f) disposed on the edge (10) of the container to coincide with the portions of pleating (d).

16. Apparatus of claim 15, wherein it further comprises folding and heat-sealing plates (109) disposed on said mobile plate (103) and able to act coinciding with said connecting plates (132) to fold the corners of the edge (10) of the container and acting as heat-sealing counter-bars with respect to the parts near the edges of said heating side plates (129)
